(19) United States
(12) Patent Application Publication
(10) Pub. No.: US 2004/0210840 A1
(43) Pub. Date: Oct. 21, 2004

(54) Printing system having a discrimination mark print function and a discrimination mark print method thereof

(76) Inventor: Dong-chae Park, Suwon-si (KR)

Correspondence Address: STANZIONE & KIM, LLP, 1740 N STREET, N.W., FIRST FLOOR, WASHINGTON, DC, 20036, US

(21) Appl. No.: 10/765,851

(22) Filed: Jan. 29, 2004

(30) Foreign Application Priority Data
Apr. 16, 2003 (KR) 2003-23934

(51) Int. Cl. G06F 17/00

(52) U.S. Cl. 715/526

(57) ABSTRACT

A printing system having a discrimination mark print function and a discrimination mark print method thereof. The discrimination mark print method of the printing system comprises: setting a discrimination mark print function based on a discrimination mark print function setting menu; formatting print data by including the discrimination mark based on the set discrimination mark print function; and sending the formatted print data to the printer based on the printer driver. As a result, discrimination marks can be printed at the same time data is printed.

### CROSS-REFERENCE TO RELATED APPLICATIONS

This application claims the benefit of Korean Patent Application No. 2003-23934 filed Apr. 16, 2003, in the Korean Intellectual Property Office, the disclosure of which is incorporated herein by reference.

### BACKGROUND OF THE INVENTION

1. Field of the Invention

The present invention relates to a printing system, and more particularly, to a printing system and a control method thereof capable of printing data inputted through a computer based on a printer driver.

2. Description of the Related Art

FIG. 1 is a block diagram showing a general printing system. In order to drive a printer, a printer driver is installed in a computer connected to the printer, and other related programs are also installed. Referring to FIG. 1, when documents prepared under an application program in a computer 10 are to be printed through a printer 30, the computer 10 should be generally installed with a printer driver 20 to drive the printer 30. If a print command is received for the printing of the document (hereinafter referred to as ‘print-target-document’) which is prepared through the application program in the computer 10, the application program sends the print command and data (hereinafter referred to as ‘print data’) of the print-target-document to the printer driver 20 through a graphic device interface (GDI). The printer driver 20 converts the print command and the print data inputted through the GDI into data that the printer 30 can recognize according to a command. Further, the converted data is sent for printing to the printer 30 through the GDI.

If a computer user works on plural documents with a computer and repeatedly gives the print commands to the printer 30, the plural documents printed through the printer 30 are continuously stacked on an exit tray. It can be stated that there is no difficulty in manually sorting the documents in a case of a few printed pages or a few printed documents, but, in the case of lots of printed pages or lots of printed documents, it needs a lot more time and effort in manually sorting the pages or the documents one by one.

In order to overcome such a problem, a method is conventionally chosen that prints a separation page every time a different document is printed. In order to print the separation page, a user sets a separation page function in printer driver registration information of an operating system so that the operating system first prints a predetermined separation page prior to printing the first page of each of the documents to be printed, thereby enabling the user to sort the printed documents by the separation page after the printing.

However, the method of sorting the documents with the separation pages printed has a few problems. That is, first, there exists a problem of wasting printing papers by printing an extra separation page every time a document is printed. Further, since the separation page can do nothing but provide a function of separating the documents from one another for sorting, the problem still remains in that considerable time and effort is needed to manually sort the documents one by one in the case of lots of documents to be printed or lots of document pages to be printed.

### SUMMARY OF THE INVENTION

Accordingly, it is an aspect of the present invention to provide a printing system having a discrimination mark print function and a discrimination mark print method thereof capable of printing discrimination marks at the same time data is printed.

Further, it is another aspect of the present invention to provide a printing system having a discrimination mark print function and a discrimination mark print method capable of formatting print data to include a discrimination mark.

It is yet another aspect of the present invention to provide a printing system having a discrimination mark print function added to printer driver functions and a discrimination mark print method thereof.

Additional aspects and/or advantages of the invention will be set forth in part in the description which follows and, in part, will be obvious from the description, or may be learned by practice of the invention.

The foregoing and/or other aspects and features of the present invention are achieved by providing a discrimination mark print method of a printing system to print data by a printer through a printer driver as a print command is inputted for the data to be printed, the method comprising: setting a discrimination mark print function based on a discrimination mark print function setting menu; formatting the print data by including the discrimination mark based on the set discrimination mark print function; and sending the formatted print data to the printer based on the printer driver.

The method further comprises selecting a discrimination mark kind based on the set discrimination mark print function.

The method further comprises setting a starting discrimination mark based on the selected discrimination mark kind.

In an aspect of the present invention, the discrimination mark print function setting menu is a submenu of printer driver registration information setting menus.

The foregoing and/or other aspects of the present invention are also achieved by providing a discrimination mark print method of a printing system to print data by a printer through a printer driver as a print command is inputted for the data to be printed, the method comprising: deciding whether a discrimination mark print function is set based on discrimination mark print function setting menus having a discrimination mark kind selection group and/or a starting discrimination mark setting option; checking a discrimination mark kind and/or a starting discrimination mark in a case that the discrimination mark print function is set; formatting the print data by including a discrimination mark based on the checked discrimination mark kind and/or starting discrimination mark; and sending the formatted print data to the printer based on the printer driver.

In an aspect of the present invention, the print method further comprises: deciding whether next print data and a print command for the next print data are inputted; and updating the current starting discrimination mark to a next starting discrimination mark and repeating the operations of checking a discrimination mark kind and/or formating the print data through the operation of sending the formatted print data to the printer in the case that the next print data and the print command for the next print data are inputted.

The foregoing and/or other aspects of the present invention are also achieved by providing a printing system printing data by a printer through a printer driver as the print data and a print command are inputted, the printing system comprising: an input unit to input a print command; and a control unit to format the print data by including a discrimination mark based on a discrimination mark print function if the discrimination mark print function is set through the input unit, and sending the print data formatted based on the print command to the printer based on the printer driver as the print command is inputted for the print data through the input unit.

In an aspect of the present invention, the printing system further comprises a storage unit to store a discrimination mark print function setting menu to set the discrimination mark print function; and a display unit to display a print menu based on the print command, wherein the control unit controls loading the stored discrimination mark print function setting menu and displaying the loaded setting menu on the display unit when a discrimination mark print function setting menu display command is inputted through the input unit as the print command.

The storage unit of the printing system further stores a formatter as a program to format the print data, and the control unit controls the formatting of the print data by including the discrimination mark when formatting the print data through the formatter in a case that the discrimination mark print function is set through the input unit.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a block diagram showing a general printing system;

FIG. 2 is a block diagram showing a printing system having a discrimination mark print function according to an embodiment of the present invention;

FIG. 3 is a view showing exemplary setting menus for printer driver registration information having a discrimination mark print function according to another embodiment of the present invention;

FIG. 4A is a view showing exemplary printed documents to which a discrimination mark print function is applied according to another embodiment of the present invention;

FIG. 4B is a view showing exemplary printed documents to which a discrimination mark print function is applied according to another embodiment of the present invention;

FIG. 5 is a flow chart showing a process to set a discrimination mark print function according to another embodiment of the present invention; and

FIG. 6 is a flow chart showing a process to print data based on a set discrimination mark print function according to another embodiment of the present invention.

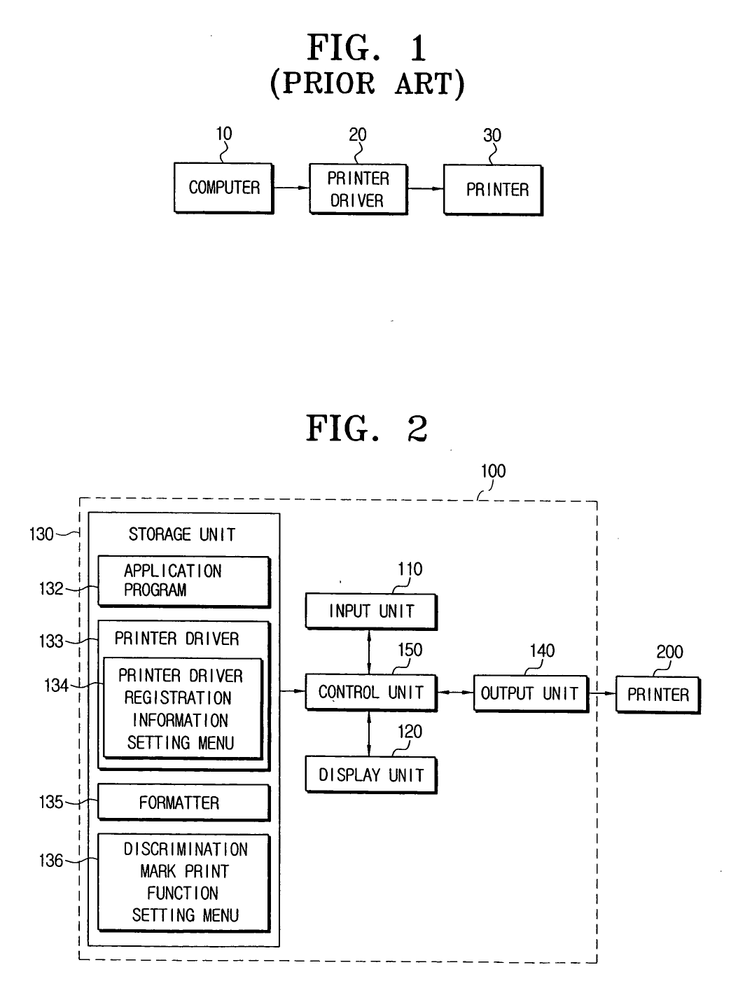

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

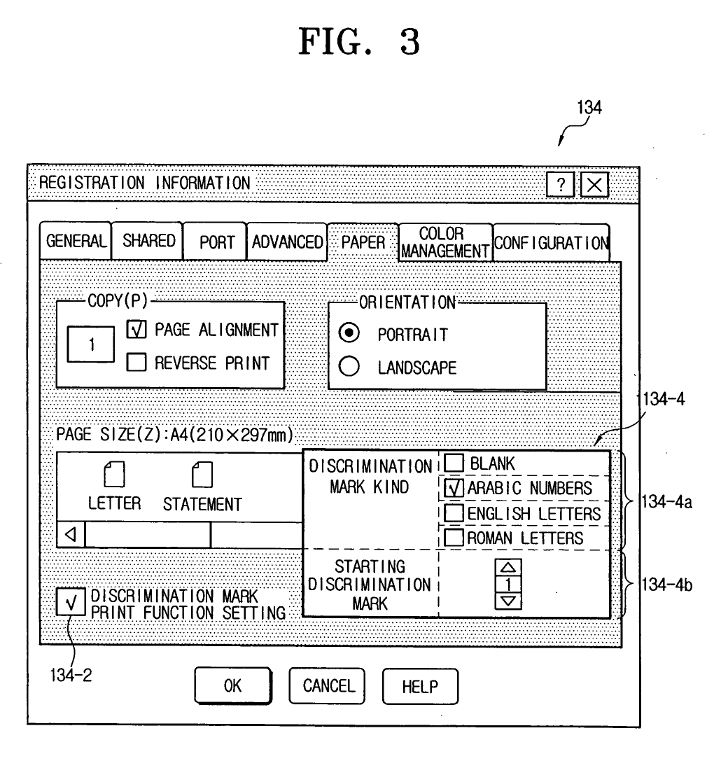

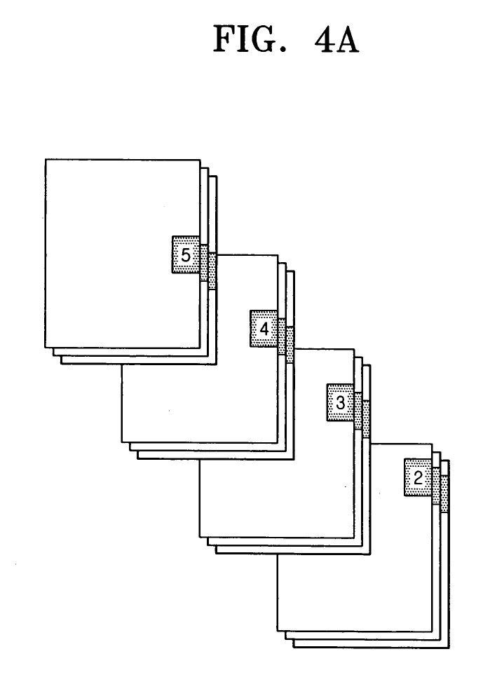

FIG. 2 is a block diagram showing a printing system having a discrimination mark print function according to an embodiment of the present invention. Further, FIG. 3 is a view showing illustrative setting menus for printer driver registration information having a discrimination mark print function according to another embodiment of the present invention.

Hereinafter, a description will be made on the printing system with reference to FIG. 2 and FIG. 3.

The printing system has a computer 100 and a printer 200. The computer 100 according to the present invention includes an input unit 110, a display unit 120, a storage unit 130, an output unit 140, and a control unit 150.

Print commands are inputted to the input unit 110. According to the present invention, jobs for a print-target-document are performed on an application program 132, and, after the job performance, a user inputs print commands through the input unit 110 when intending to print the print-target-document. Further, a display command for a printer driver registration information setting menu is inputted through the input unit 110 to display on the display unit 120 a printer driver registration information setting menu 134 having a plurality of menus which are shown in FIG. 3, including a discrimination mark print function setting menu 134-4 as a submenu of one of the menus. However, in a case that a discrimination mark print function setting menu 136 is separately provided, another display command for the discrimination mark print function setting menu 136 can be inputted through the input unit 110 to display the discrimination mark print function setting menu 136 on the display unit 120. Further, a selection command and a setting command are respectively inputted through the input unit 110 even when a discrimination mark kind is selected, and a starting discrimination mark is set in the discrimination mark print function. Commands to launch the other application programs are inputted through the input unit 110.

The display unit 120 displays a print menu according to the controls of the control unit 150 based on a print command inputted through the input unit 110. However, in a case that the discrimination mark print function setting menu 136 is separately provided and the display command for the discrimination mark print function setting menu is inputted through the input unit 110, the discrimination mark print function setting menu 136 stored in the storage unit 130 is loaded and displayed on the display unit 120 by the controls of the control unit 150.

The storage unit 130 stores a printer driver 133, a formatter 135, an application program 132, and the discrimination mark print function setting menu 136. However, the discrimination mark print function setting menu 136 is separately provided in the embodiment of FIG. 2, whereas the discrimination mark print function setting menu is shown as the submenu 134-4 of the printer driver registration information setting menu 134 in the embodiment of FIG. 3.

The application program 132 is launched based on a user's application program launch command, and used by a user to prepare the print-target-document. A print command for the print-target-document is inputted through the input unit 110 on the application program 132.

The printer driver 133 serves to convert the print data of the print-target-document prepared in the application program 132 into data interpretable in the printer 200. That is, if a print command is inputted for a print-target-document prepared in the application program 132 of the computer 100, the printer driver 133 divides print data by pages, processes the data, control codes, and so on, that are included in the print data for each page, and converts the print data into interpretable data.

Further, the printer driver 133 performs jobs based on registration information set in the printer driver registration information setting menu 134. The menus of the printer driver registration information setting menu 134 are described as follows with reference to FIG. 3. Provided in the printer driver registration information setting menu 134 according to the present embodiment are a general information setting menu, a shared information setting menu, a port information setting menu, an advanced information setting menu, a paper information setting menu, a color management information setting menu, and a configuration information setting menu as the menus. Further, the discrimination mark print function setting option 134-2 is provided in the paper information setting menu according to the present invention. If the paper information setting menu is displayed on the display unit 120, a user can select the discrimination mark print function setting option 134-2.

In this case, the present embodiment processes the discrimination mark print function submenu 134-4 to be displayed if the discrimination mark print function setting option 134-2 is selected. The discrimination mark print function submenu 134-4 includes a selection group 134-4a for discrimination mark kinds and a setting option 134-4b for a starting discrimination mark. A user can select a discrimination mark kind and a starting discrimination mark that he or she desires through the selection group 134-4a and the setting option 134-4b. A predetermined region of the storage unit 130 stores data for the selected discrimination mark kind and data for the starting discrimination mark. Further, if a printing process for a print document is completed, the control unit 150 updates and stores data for a next starting discrimination mark instead of data stored in the region for a current starting discrimination mark. The discrimination mark kinds include ‘Blank’, ‘Arabic numbers’, ‘English letters’, and ‘Roman letters’, for example, in the present embodiment. In a case that any of the kinds is selected, the setting option 134-4b for the starting discrimination mark is preferably changed based on the selected discrimination mark kind. For example, if a user selects the ‘English letters’ from the discrimination mark kind selection group 134-4a when set as shown in FIG. 3, the starting discrimination mark is changed to an English letter ‘A’ from an Arabic number ‘1’.

In another embodiment, it can be predetermined to display all of the discrimination mark print function setting option, the discrimination mark kind selection group, and the starting discrimination mark setting option in the paper information setting menu.

In yet another embodiment, the discrimination mark print function setting menu 136 can be separately predetermined without a discrimination mark print function added in the printer driver 133, enabling the discrimination mark print function to be set.

The formatter 135 is a program to format print data by adjusting left and right margins, alignments, rows, spaces, fonts, font sizes, and so on, for every page to output documents in a particular shape or pattern to the display unit 120 or the printer 200 based on the controls of the control unit 150. In the case where the discrimination mark print function according to the present invention is set, a discrimination mark is added to print data and formatted according to a preset discrimination mark kind and a starting discrimination mark upon formatting the print data under the controls of the control unit 150.

The output unit 140 outputs to the printer 200 the print data converted into a format that can be recognized by the printer 200 through a predetermined process based on the controls of the control unit 150.

The control unit 150 controls the overall operations of the computer 100 based on a user command inputted through the input unit 110. The control unit 150 loads and drives the printer driver 133 and the formatter 135 stored in the storage unit 130 based on a print command inputted through the input unit 110. Further, the driven printer driver 133 and formatter 135 control the converting and formatting processes for the print data, respectively.

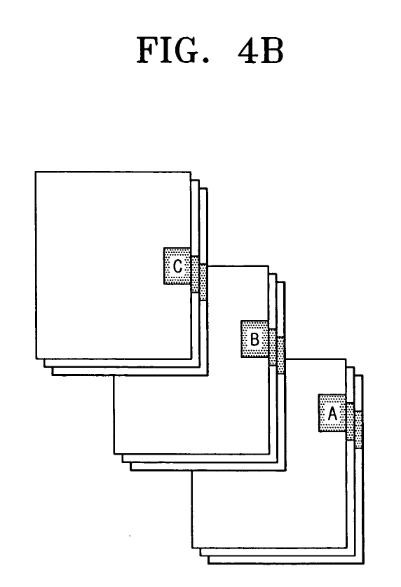

FIG. 4A and FIG. 4B are views showing exemplary printed documents to which the discrimination mark print function is applied according to another embodiment of the present invention.

FIG. 4A shows a result of printing jobs for four documents when ‘2’ is selected for a starting discrimination mark and the ‘Arabic numbers’ is selected for the discrimination mark kind, and FIG. 4B shows a result of printing jobs for three documents when ‘A’ is selected for the starting discrimination mark and the ‘English letters’ is selected for the discrimination mark kind.

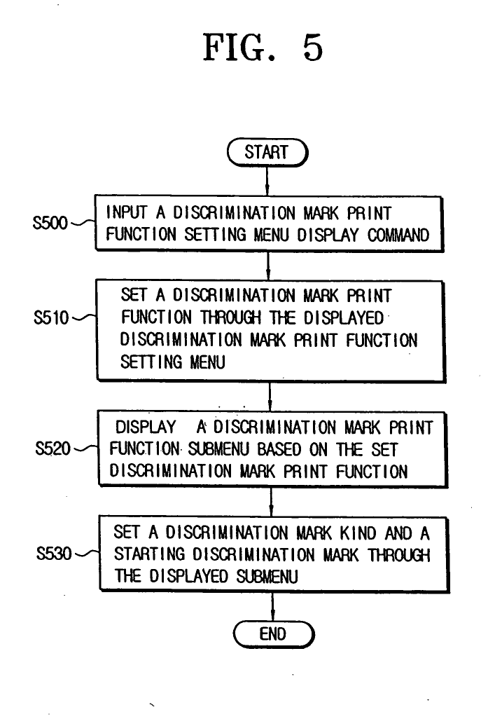

FIG. 5 is a flow chart showing a process to set a discrimination mark print function according to an embodiment of the present invention. Here, the embodiment of FIG. 5 displays the discrimination mark print function submenu if the discrimination mark print function setting option is selected.

In order to print a discrimination mark on a print-target-document, a user first sets a discrimination mark print function. To do so, the user inputs a display command for the discrimination mark print function setting menu through the input unit 110 (S500). Thus, the discrimination mark print function setting menu is displayed on the display unit 120 based on the display command inputted for the discrimination mark print function setting menu. The user sets the discrimination mark print function through the displayed menu (S510). The discrimination mark print function submenu is overlapped over the discrimination mark print function setting menu and displayed on the display unit 120 by the setting of the discrimination mark print function (S520). The discrimination mark print function submenu 134-4 includes the discrimination mark kind selection group and the starting discrimination mark setting option as aforementioned. The user then selects a discrimination mark kind and a starting discrimination mark he or she wants (S530).

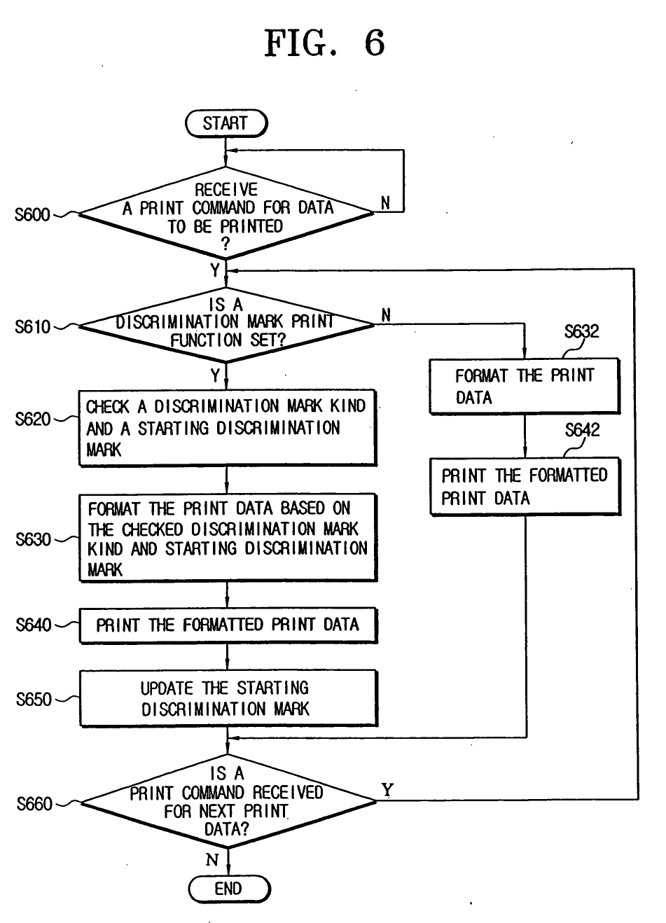

FIG. 6 is a flow chart showing a process to print data based on the discrimination mark print function set according to the present invention.

If a user works on documents to be printed with an application program and inputs a print command (S600), the control unit 150 decides whether a discrimination mark print function is set based on the print command (S610).

If the discrimination mark print function is not set as a result of the decision on whether the discrimination mark print function is set, when the data to be printed is formatted by the formatter 135 (S632) and outputted to the printer 200, the printer 200 prints the formatted data through a predetermined process (S642).

If the discrimination mark print function is set as a result of the decision on whether the discrimination mark print function is set, the control unit 150 checks a discrimination mark kind and a staring discrimination mark (S620). Further, the control unit 150 includes in the to-be-printed data and formats a discrimination mark based on the selected discrimination mark kind and starting discrimination mark when driving the formatter 135 to perform a formatting job (S630). Thereafter, the data is printed by the printer 200 through a predetermined process (S640). At this time, on the document is printed the discrimination mark selected by the user. Further, the control unit 150 updates the data for the discrimination mark stored in a predetermined region of the storage unit 130 into data for a next discrimination mark. That is, in the case of FIG. 3, the control unit 150 updates the Arabic number ‘1’ to ‘2’ (S650). Thereafter, the control unit 150 decides whether a print command is inputted for data for a next document to be printed (S660). If the print command for the next document is inputted as a result of the decision, the steps 610, 620, 630, 640, and 650 are repeated.

As described so far, the printing system according to the present invention facilitates sorting plural documents after printing jobs, and enables the individual documents to be intuitively sorted with ease even in the case of lots of printed pages or lots of printed documents, since the printing system can print the discrimination marks at the same time data is printed. Further, since a different discrimination mark is printed for each document even when plural documents are printed, the printing system has an advantage of eliminating the need to give an extra classification mark to every document even when the documents are to be kept.

Although the preferred embodiments of the present invention have been described, it will be understood by those skilled in the art that the present invention should not be limited to the described preferred embodiments, but various changes and modifications can be made within the spirit and scope of the present invention as defined by the appended claims and their equivelents.

What is claimed is:

1. A discrimination mark print method of a printing system printing data by a printer through a printer driver as a printing command is inputted for the data to be printed, the method comprising:
setting a discrimination mark print function based on a discrimination mark print function setting menu;
formatting the data by including the discrimination mark based on the set discrimination mark print function; and
sending the formatted data to the printer based on the printer driver.

2. The discrimination mark print method as claimed in claim 1, further comprising selecting a discrimination mark kind based on the set discrimination mark print function.

3. The discrimination mark print method as claimed in claim 2, further comprising setting a starting discrimination mark based on the selected discrimination mark kind.

4. The discrimination mark print method as claimed in claim 1, wherein the discrimination mark print function setting menu is a submenu of a printer driver registration information setting menu.

5. A control method used with a printing system printing data by a printer through a printer driver as a print command is inputted for the data to be printed, the method comprising:
deciding whether a discrimination mark print function is set based on a discrimination mark print function setting menu having a discrimination mark kind selection group and/or a starting discrimination mark setting option;
checking a discrimination mark kind and/or a starting discrimination mark in a case that the discrimination mark print function is set;
formatting the data by including a discrimination mark based on the checked discrimination mark kind and/or the starting discrimination mark; and
sending the formatted data to the printer based on the printer driver.

6. The control method as claimed in claim 5, further comprising:
deciding whether next print data and another print command for the next print data are inputted; and
updating the current starting discrimination mark to a next starting discrimination mark and repeating the operations of checking a discrimination mark kind and/or a starting discrimination mark to sending the formatted print data to the printer based on the printer driver in case that the next print data and the another print command for the next print data are inputted.

7. The control method as claimed in claim 5, wherein the discrimination mark kinds include “Blank,” “Arabic numbers,” English letters,” and “Roman letters.”

8. A printing system printing data by a printer through a printer driver as the data and a print command are inputted, comprising:
an input unit to input a print command; and
a control unit to format the data by including a discrimination mark based on a discrimination mark print function if the discrimination mark print function is set through the input unit, and to send the formatted data based on the print command to the printer based on the printer driver as the print command is inputted for the data through the input unit.

9. The printing system as claimed in claim 8, further comprising:
a storage unit to store a discrimination mark print function setting menu to set the discrimination mark print function; and
a display unit to display a print menu based on the print command, wherein the control unit controls loading the stored discrimination mark print function setting menu and displaying the loaded setting menu on the display unit when a discrimination mark print function setting menu display command is inputted through the input unit as the print command.

10. The printing system as claimed in claim 9, wherein the storage unit further stores a formatter as a program to format the data, and the control unit controls the formatting of the data by including the discrimination mark when formatting the print data through the formatter in the case that the discrimination mark print function is set through the input unit.

11. A printing system to print data through a printer driver comprising:
a storage unit comprising:
an application program to prepare a print-target-document by receiving a print command,
a discrimination mark print function setting menu to select a discrimination mark kind and/or a starting discrimination mark,
a formatter to format the print data and the discrimination mark according to the preset discrimination mark kind and the starting discrimination mark, and
the printer driver to convert the print data of the print-target-document to be printed;
an input unit to input the print command to print to a print-target-document and a display command for the discrimination mark print function setting menu; and
a control unit to load and drive the printer driver and the formatter based on the commands inputted through the input unit.

12. The printing system as claimed in claim 11, further comprising a display unit to display the discrimination mark print function setting menu, the discrimination marks input and the print data.

13. A printing system to print data on one or more sheets, comprising:
a control unit to add a discrimination mark to the data to generate formatted data to be printed on the one or more sheets so that the one or more sheets include the same discrimination mark.

14. The printing system as claimed in claim 13, wherein the control unit receives second data to be printed on one or more second sheets and adds a second discrimination mark to the second data to generate second formatted data to be printed on the one or more second sheets so that the one or more second sheets include the same discrimination mark.

15. The printing system as claimed in claim 14, further comprising:
a display unit to display a discrimination mark print function setting menu showing a discrimination mark kind corresponding to the discrimination mark and the second discrimination mark, wherein one of the discrimination mark and the second discrimination mark is selected according to the data and the second data.

16. The printing system as claimed in claim 14, wherein the printing system comprises a printer in which the control unit is installed.

17. The printing system as claimed in claim 14, wherein the printing system comprises a computer connectable to a printer printing the data and the second data, and the control unit is installed in the computer outputting the formatted data and the formatted second data to the printer to print the formatted data and the formatted second data on the one or more sheets and the one or more second sheets, respectively.

18. The printing system as claimed in claim 14, further comprising:
a storage unit to store the discrimination mark and the second discrimination mark and to store a program, wherein the discrimination mark and the second discrimination mark are selected and added to the data and the second data, respectively, according to the program.

19. The printing system as claimed in claim 14, further comprising:
a storage unit to store a plurality of discrimination marks, wherein the discrimination mark and the second discrimination mark are selected from the stored discrimination marks.

20. The printing system as claimed in claim 14, wherein the same second discrimination mark is printed on the same location of the one or more second sheets.

21. The printing system as claimed in claim 13, wherein the same discrimination mark is printed on the same location of the one or more sheets.

22. A method used with a printing system to print data on one or more sheets, the method comprising:
adding a discrimination mark to the data to generate formatted data to be printed on the one or more sheets so that the one or more sheets include the same discrimination mark.

23. The method as claimed in claim 22, wherein the adding of the discrimination mark to the data comprises locating the discrimination mark on the same location of the one or more sheets in the formatted data.

24. The method as claimed in claim 22, further comprising:
receiving second data to be printed on one or more second sheets; and
adding a second discrimination mark to the second data to generate second formatted data to be printed on the one or more second sheets so that the one or more second sheets include the same discrimination mark.

25. The method as claimed in claim 24, wherein the adding the second discrimination mark to the second data comprises locating the second discrimination mark on the same location of the one or more second sheets in the second formatted data.
